(19) United States
(12) Patent Application Publication
(10) Pub. No.: US 2024/0311407 A1
(43) Pub. Date: Sep. 19, 2024

(54) ARTIFICIAL INTELLIGENCE AGRICULTURAL ADVISOR CHATBOT

(71) Applicant: Farmer's Business Network, Inc., San Carlos, CA (US)

(72) Inventors: Christopher Barron, San Francisco, CA (US); Walter T. Dado, Santa Monica, CA (US); Graham Jeffries, Rockland, ME (US); Alexander MacDonald, San Francisco, CA (US); Edward Rowe, Los Altos, CA (US)

(73) Assignee: Farmer's Business Network, Inc., San Carlos, CA (US)

(21) Appl. No.: 18/607,454

(22) Filed: Mar. 16, 2024

Related U.S. Application Data
(60) Provisional application No. 63/453,040, filed on Mar. 17, 2023.

(51) Int. Cl. G06F 16/332; G06F 16/33; G06Q 50/02

(52) U.S. Cl. CPC G06F 16/3329; G06F 16/3344; G06Q 50/02

(57) ABSTRACT

An artificial intelligence agricultural advisor chatbot system powered by large language models (LLMs) and customized for the agricultural domain using a blend of agricultural datasets can include tools providing custom context relevant to user queries. The chatbot system can apply an LLM to formulate conversational responses to user queries based on the custom context. Various tools can be employed in the chatbot system to facilitate user access to agricultural information, such as product label data. A natural language processing algorithm is applied to convert agricultural data from digital files into vector embeddings representing semantically coherent text segments and question-answer pairs, and the vector embeddings are stored in a database for retrieval during formulation of LLM prompts based on user queries. Fine-tuning and prompt-based learning approaches make the chatbot interact with a user in a way similar to an agricultural professional.

### CROSS-REFERENCE TO RELATED APPLICATION

This application claims the benefit of U.S. Provisional Application No. 63/453,040, filed Mar. 17, 2023, entitled “ARTIFICIAL INTELLIGENCE AGRICULTURAL ADVISOR CHATBOT,” which application is incorporated herein by reference in its entirety for all purposes.

### FIELD

The field generally relates to facilitating user access to agricultural product data using dialog-based artificial intelligence (AI) tools.

### BACKGROUND

In agriculture, product labels are the legally required usage instructions that accompany many crop input products. These labels can be 75+ pages long and often contain mixed formatting, from text to charts and tables. The format of these product labels makes them very challenging for people to interpret and even harder for computers to interpret. However, they are necessary to consult as they contain the legally approved application rates, methods, timing, for each crop and target pest.

As a result of the inscrutability of these product labels, farmers often have to rely on trained agronomists or risk making application decisions with incomplete information. When an agronomist is not available (e.g., on nights and weekends), farmers may not have the information required to complete a given time-sensitive task. This results in suboptimal decision making, delays vital cropping practices, and can even result in a farmer unintentionally not complying with the law.

Accordingly, there remains a need for improved user access to agricultural product data.

### BRIEF DESCRIPTION OF THE DRAWINGS

FIG. 1 is a block diagram of an example system implementing an artificial intelligence agricultural advisor chatbot.

FIG. 2 is a flowchart of an example method of implementing an artificial intelligence agricultural advisor chatbot.

FIG. 3 is a flowchart of an example method of responding to a text query input to a chatbot.

FIG. 4 is a flowchart of an example method of generating vector embeddings.

FIG. 5 is a flow diagram for generating vector embeddings.

FIG. 6 is a flowchart of an example method of selecting a database entry relevant to a chatbot query.

FIG. 7 is a block diagram of an example architecture of an artificial intelligence agricultural advisor chatbot.

FIG. 8 is a block diagram of an example computing system in which described embodiments can be implemented.

FIG. 9 is a block diagram of an example cloud computing environment that can be used in conjunction with the technologies described herein.

### DETAILED DESCRIPTION

### Example 1—Example Overview

A provider can provide access to an AI agricultural (e.g., agronomic) advisor chatbot system powered by Large Language Models (LLMs) and customized for the agriculture domain using a blend of agricultural datasets. The technology can leverage an LLM chatbot architecture and customize it for agriculture by integrating a unique corpus of agricultural data, a custom context extraction process, as well as domain-specific prompt-based learning inputs and fine-tunings. The sources for the agricultural knowledge corpus include public agronomic information (e.g., public datasets such as USDA-NASS survey data or the like), semi-public agronomic information, academic and professional literature, social media, traditional media, and proprietary data sources (e.g., proprietary agronomic information).

The chatbot system can include tools that provide custom context relevant to a user's question and enable the chatbot to access the detailed agricultural knowledge corpus efficiently. Accordingly, an LLM implemented in the chatbot system can formulate a conversational response to the question based on the custom context, rather than based on the LLM's baked-in training data. Fine-tuning and prompt-based learning approaches make the chatbot interact with a user in a way similar to an agricultural professional.

One example tool that can be included in the chatbot system is a product label tool which extracts data from digital files (e.g., Portable Document Format (PDF) files) that contain label data for agricultural products such as chemical products to be applied to crops. The label data for a given agricultural product can include usage instructions for the product, among other data. The product label tool can perform custom processing on the extracted data to generate semantically coherent text segments and question-answer pairs from the extracted text. The semantically coherent text segments and question-answer pairs are transformed into vector embeddings and stored in a custom vector database of the chatbot system to facilitate retrieval of relevant information when a user inputs a query related to the product's label data.

Other example tools that can be included in the chatbot system include a product finder and usage tool and a complementary product recommendation tool. The product finder and usage tool can allow users to quickly check whether a product (e.g., chemical product) on-hand might also be labeled for use with a new pest, weed, or disease issue they are attempting to mitigate. The complementary product recommendation tool can provide product recommendations to users for specific chemical products in response to queries.

In addition to the use cases associated with the example tools described herein, the chatbot is designed to serve a variety of other purposes, such as answering basic agronomy questions; assisting a user in the design of a specific and executable program of crop protection, seed, fertility, and livestock nutrition inputs tailored to their farm; aiding in the scheduling of product delivery; writing agronomic content for a blog; and writing appraisal narratives for a land loans business. Taken together, the robust blend of public and proprietary agronomic data sources, the unique approach to industry-specific training of the model, and the novel use cases associated with the AI agricultural advisor chatbot system described herein constitute a wholly new approach to providing agricultural advice to farmers.

### Example 2—Example System Implementing an Artificial Intelligence Agricultural Advisor Chatbot

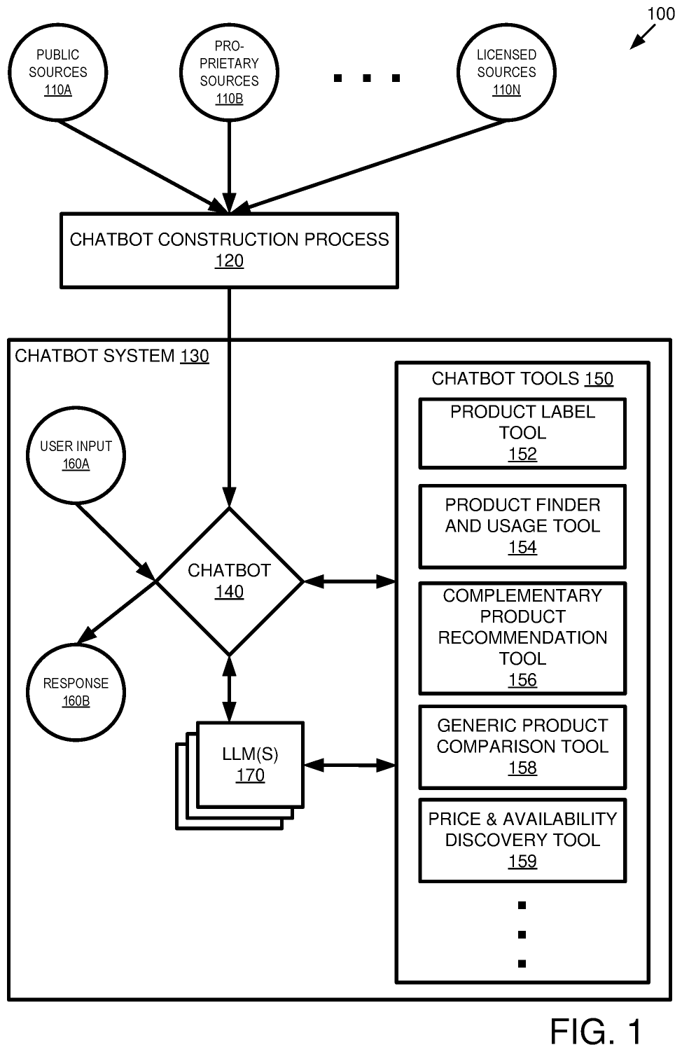

FIG. 1 is a block diagram of an example system 100 implementing an AI agricultural advisor chatbot. In the example, a plurality of data sources 110A . . . N serve as inputs to a chatbot construction process 120. The process 120 creates an AI agricultural advisor chatbot system 130 including a chatbot 140 and a plurality of chatbot tools 150. Chatbot 140 is operable to receive user input 160A and output a response 160B. To formulate the response 160B, chatbot 140 can employ one or more of the chatbot tools 150 and one or more LLMs 170. In practice, a conversation between a user and the chatbot 140 can be supported on a variety of agronomic topics.

The data sources 110A . . . N can be sources of agronomic information including, for example, public sources 110A (e.g., USDA-NASS survey data, EPA data, or the like), proprietary sources 110B (e.g., seed performance data, provider data, or the like), and licensed sources 110N (e.g., third party sources of data such as product label data).

The chatbot construction process 120 can include data pre-processing and normalization, assembling an agricultural knowledge corpus, and the like. For example, as described herein, data from the data sources 110A . . . N can be extracted from digital files and processed to generate semantically coherent text segments and question-answer pairs which are embedded as vectors and stored in a database (e.g., a vector database). The database can be part of a knowledge corpus of the chatbot system 130.

Chatbot system 130 further includes a plurality of chatbot tools 150. Each “tool” can include computer-executable instructions that, when executed by a computing system, cause the computing system to perform operations to achieve the functionality of the tool described herein. In the depicted example, chatbot tools include a product label tool 152, a product finder and usage tool 154, a complementary product recommendation tool 156, a generic product comparison tool, and a price and availability discovery tool 159. Chatbot tools 150 can also include other tools in addition to those depicted in FIG. 1.

The product label tool 152 can be configured to perform custom processing on product label data received from data sources 110A . . . N (e.g., licensed product label data received from a data aggregator). For example, the product label tool 152 can apply a natural language processing algorithm to group text extracted from digital files containing product label data (e.g., PDF files) into semantically coherent text segments which contain relevant context for a specific subsection of the product label, and applying LLMs to generate question-answer pairs from the extracted text. As used herein, a “semantically coherent text segment” refers to a text segment which contains the necessary context and information to be interpreted independently from the rest of the text in the digital file from which it was extracted. The semantically coherent text segments and question-answer pairs are transformed into vector embeddings and stored in a custom vector database of the chatbot system. Storing the label data in this manner facilitates retrieval of relevant information by the chatbot in response to user queries regarding associated product. For example, when a user submits a query to the chatbot that references a particular product, the chatbot system can initiate a retrieval process which searches the vector database for relevant entries (e.g., entries with similar semantic information and which originated from the label data for that product). As described herein, an additional LLM can be applied during the retrieval process to improve the accuracy of the results.

The product finder and usage tool 154 can be configured to assist the chatbot in handling unstructured queries related to identifying appropriate agricultural products and/or agricultural product usage details for a specified application. For example, when a user enters an unstructured query to the chatbot, the chatbot can employ the product finder and usage tool 154 to determine whether the query relates to checking chemical registrations for specific pests and/or crops. If so, the product finder and usage tool 154 can further analyze the query to determine whether the user wishes to check the registration of a specific chemical in the database or whether it should instead provide a selection of products in the database which match the user's filters (e.g., the crop and pest/disease/weed referenced in the query). In addition, the product finder and usage tool 154 can assist the chatbot with determining the labeled rates of product usage for the referenced crop(s) so that the chatbot can provide this information if prompted by the user.

The complementary product recommendation tool 156 can provide product recommendations to users for specific chemical products in response to queries. For example, when a user submits a natural language query requesting a recommendation for a complementary product, the chatbot system can employ the complementary product recommendation tool to determine an appropriate response by querying an internal database which maps chemical products to complementary products (e.g., adjuvant pairings).

The generic product comparison tool 156 can provide similar and alternative products to a particular agricultural chemical product. Farmers have a wide array of branded crop protection products to choose from, and each year the major crop protection manufacturers release new products into the market. These products are often merely novel combinations of generically available products, but are branded with names that provide the appearance of a new product. In addition, the names chosen for these products typically have nothing to do with the actual formulations. Rather, the product names provide the cache of a branded product and often allow the manufacturer to charge significantly higher product margin than equivalent blends of generic products. However, for a farmer, it is not always clear whether the constituent products in a branded blend are available in the generic market. The generic product comparison tool 156 can be employed in the chatbot system to address these issues. For example, using the generic product comparison tool 156, the chatbot system can answer questions about the composition of a blended product and recommend generic alternatives. This can help farmers have more control over their purchases and save significant amounts of money.

For example, when a user submits a natural language query regarding this topic (e.g. “What are generic or branded alternatives to [insert branded product name]?”), the chatbot system 130 can employ the generic product comparison tool 156 to detect the user's intent with the question and query an internal database which maps chemical products to one or more similar products (e.g., based on usage, active ingredient, and active ingredient concentrations). In order to effectively query the database, the chatbot system 130 leverages its context extraction module which can accurately detect the official product name based on the user's natural language query. The chatbot system can then produce a response which includes the relevant products.

The price and availability discovery tool 159 can be employed by the chatbot system 130 to respond to user queries regarding price, availability, and other details of agricultural products. For example, users can submit natural language queries to check on price, availability, active ingredient composition, typical spray rates, and other details of agricultural products (e.g., agricultural chemical products). In response to such a query, the chatbot system 130 detects the user's intent using the context extraction module, identifying both (1) the type of information about the product the user is seeking and (2) the particular product the user is asking about. The price and availability discovery tool 159 can then search an internal database of the chatbot system 130 for desired information regarding the product in question and return an answer with those details. Towards this end, the price and availability discovery tool 159 can be configured to access per-unit prices, total prices, as well as prices for different variations within a product (e.g., different bulk quantities which may impact the per-unit price).

Chatbot system 130 further includes one or more LLMs 170. While the LLMs 170 are depicted as being part of (e.g., internal to) the chatbot system 130, one or more of the LLMs can alternatively be hosted by an entity external to the chatbot system 130. As described herein, the LLMs 170 can include a first LLM configured to receive a prompt formulated by the chatbot system 130 and generate an answer based on the prompt, a second LLM configured to perform a database retrieval process, a third LLM configured to identify database entries relevant to a query, and a fourth LLM configured to generate question-answer pairs from text. In some examples, the first, second, third, and fourth LLMs are different LLMs (e.g., different types of LLMs). In other examples, the same LLM serves as two or more of the first, second, third, and fourth LLMs. While four LLMs are described herein, a smaller or larger number of LLMs 170 can be employed by the chatbot system 130.

Any of the systems herein, including the system 100, can comprise at least one hardware processor and at least one memory coupled to the at least one hardware processor.

The system 100 can also comprise one or more non-transitory computer-readable media having stored therein computer-executable instructions that, when executed by the computing system, cause the computing system to perform any of the methods described herein.

In practice, the systems shown herein, such as system 100, can vary in complexity, with additional functionality, more complex components, and the like. For example, the chatbot 140 can interact with numerous users in a cloud-based scenario. There can be additional functionality within the construction process. Additional components can be included to implement security, redundancy, load balancing, report design, and the like.

The described computing systems can be networked via wired or wireless network connections, including the Internet. Alternatively, systems can be connected through an intranet connection (e.g., in a corporate environment, government environment, or the like).

The system 100 and any of the other systems described herein can be implemented in conjunction with any of the hardware components described herein, such as the computing systems described below (e.g., processing units, memory, and the like). In any of the examples herein, the data sources 110A-N, chatbot 140, chatbot tools 150, user input 160A, chatbot response 160B, LLM(s) 170, and the like can be stored in one or more computer-readable storage media or computer-readable storage devices. The technologies described herein can be generic to the specifics of operating systems or hardware and can be applied in any variety of environments to take advantage of the described features.

### Example 3—Example Method Implementing an Artificial Intelligence Agricultural Advisor Chatbot

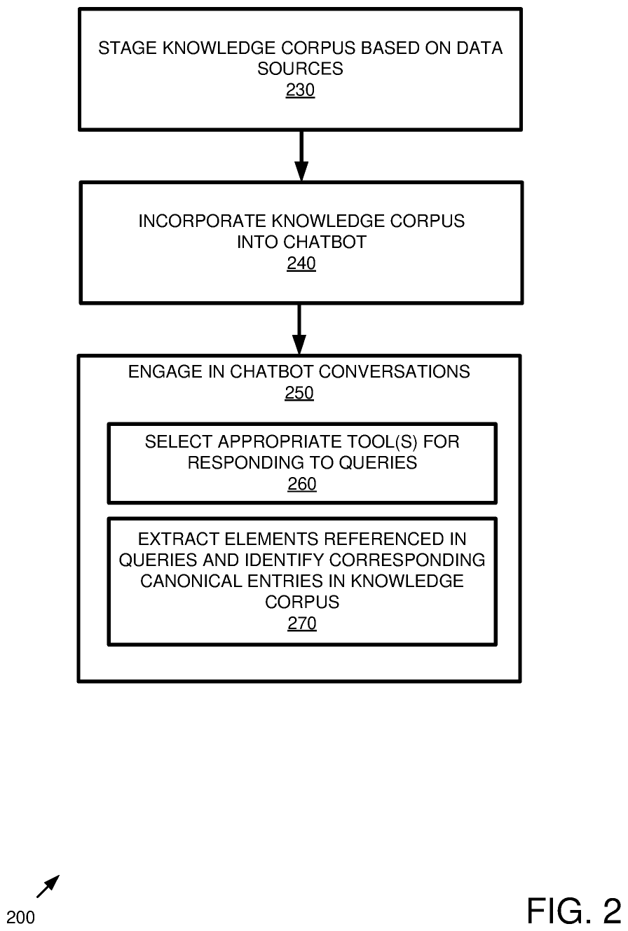

FIG. 2 is a flowchart of an example method 200 of implementing an artificial intelligence agricultural advisor chatbot and can be performed, for example, by the system of FIG. 1. The automated nature of the method 200 can be used in a variety of situations such as assisting users in answering questions, providing general agricultural advice, performing tasks related to running an agricultural business, or the like.

In the example, at 230, a knowledge corpus is staged based on a plurality of data sources, such as data sources 110A . . . N of FIG. 1.

At 240, the knowledge corpus is incorporated into the chatbot.

At 250, the chatbot engages in conversations. As shown, this can include selecting one or more appropriate tools for responding to queries at 260. Engaging in chatbot conversations can also include, at 270, extracting elements referenced in the queries and identifying corresponding canonical entries in the knowledge corpus.

The method 200 and any of the other methods described herein can be performed by computer-executable instructions (e.g., causing a computing system to perform the method) stored in one or more computer-readable media (e.g., storage or other tangible media) or stored in one or more computer-readable storage devices. Such methods can be performed in software, firmware, hardware, or combinations thereof. Such methods can be performed at least in part by a computing system (e.g., one or more computing devices).

The illustrated actions can be described from alternative perspectives while still implementing the technologies. For example, receiving data can be described as sending data depending on perspective.

### Example 4—Example Method for Responding to a Text Query

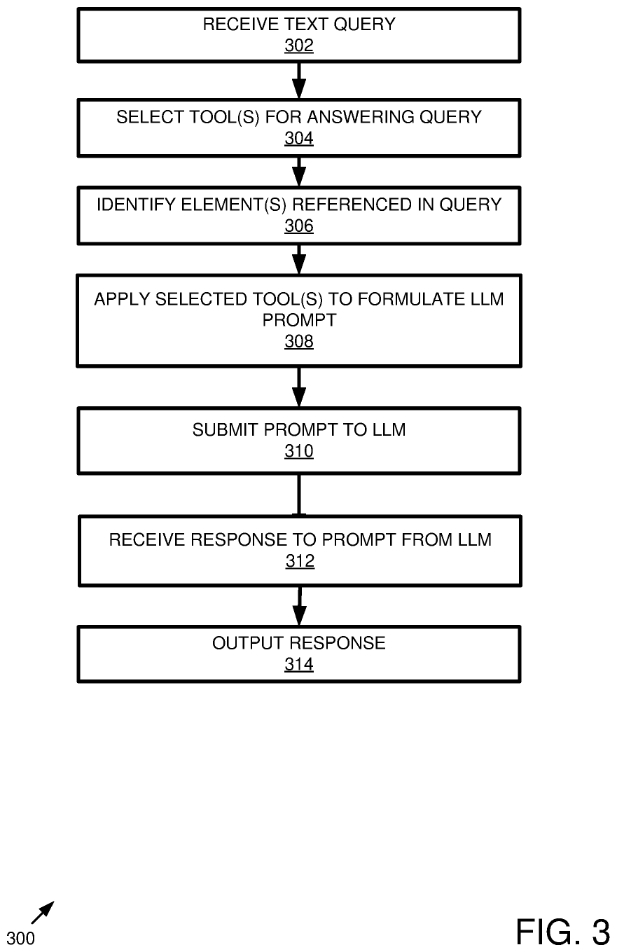

FIG. 3 is a flowchart of an example method 300 for responding to a text query submitted to a chatbot, such as an artificial intelligence agricultural advisor chatbot, and can be performed, for example, by the system of FIG. 1.

In the example, at 302, a text query is received, e.g., from a user via a user interface. The text query can be an unstructured query containing a question that references one or more elements. As used herein, the term “element” can represent a particular agricultural product (e.g., chemical product name), agricultural chemical, crop, pest, or other entity.

At 304, one or more tools are selected for answering the query. For example, the chatbot system can reference information in its knowledge corpus (e.g., previous questions and answers) to determine which types of information will be required to answer the question. Based on this determination, the chatbot system can select one or more tools from its set of tools (e.g., chatbot tools 150 of FIG. 1) which can provide the appropriate information.

At 306, one or more elements referenced in the query are identified. For example, the chatbot system can input the query to an LLM (e.g., one of LLMs 170 of FIG. 1), and the LLM can identify any elements referenced in the query. The LLM used in this context can be a general foundation model, for example. The chatbot system can then perform structured and natural language processing on any identified elements to convert the user's input for the element into a “canonical” entry. For example, when the element is a chemical product, the canonical entry for the element can be the official registered name of the chemical product. Accordingly, the chatbot system can harness LLMs to intelligently interpret a user's informal input as referencing a particular element, and then perform additional processing to convert the user input into a canonical entry for the element.

At 308, the selected tool(s) are applied to formulate a prompt for an LLM. Applying a tool can include executing code associated with the tool by one or more processors of the chatbot system to produce an output (e.g., a text output). The output of the tool can then be used by the chatbot system to formulate a prompt for an LLM (e.g., another one of LLMs 170). In some examples, the prompt comprises structured examples of questions and answers to guide the LLM in formulating an appropriate response (e.g., a response which best matches a desired output in format, tone, and content).

At 310, the prompt is submitted to the LLM. The LLM receiving the prompt can be an AI or machine learning model that is designed to understand and generate human language. Such models typically leverage deep learning techniques such as transformer-based architectures to process language with a very large number (e.g., billions) of parameters. Examples include the Generative Pre-trained Transformer (GPT) developed by OpenAI (e.g., ChatGPT), Bidirectional Encoder Representations from Transforms (BERT) by Google, A Robustly Optimized BERT Pretraining Approach developed by Facebook AI, Megatron-LM of NVIDIA, or the like. Pretrained models are available from a variety of sources.

At 312, a response to the prompt is received from the LLM.

At 314, the response is output by the chatbot system. For example, the chatbot system can output the response to the user who initially submitted the text query via a user interface.

### Example 5—Example Method for Generating Vector Embeddings

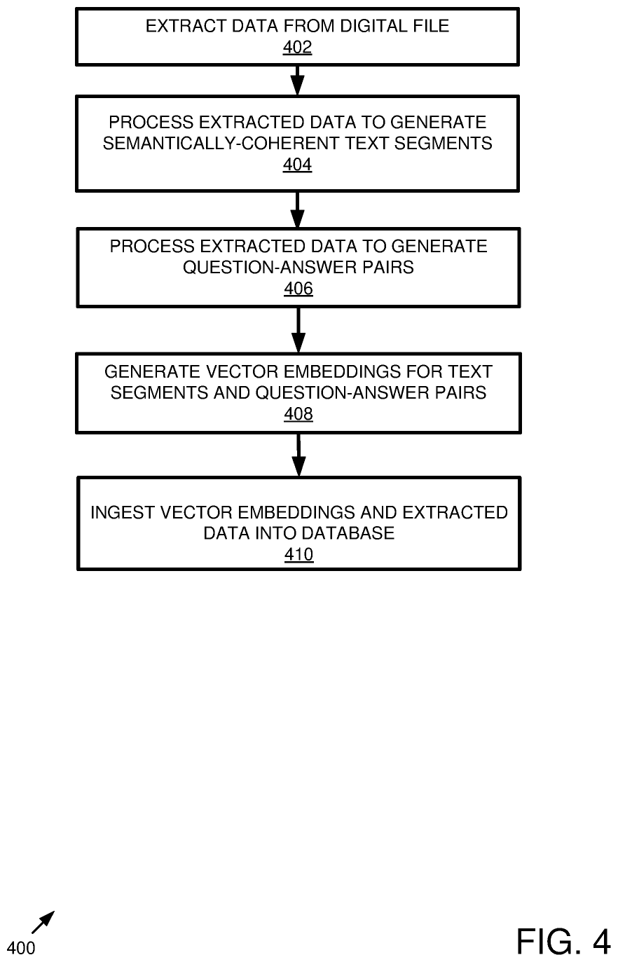

FIG. 4 is a flowchart of an example method 400 of generating vector embeddings for use by an AI agricultural advisor chatbot and can be performed, for example, by the system of FIG. 1. A chatbot tool, such as product label tool 152 of FIG. 1, can perform method 400 to facilitate retrieval of data by the chatbot when responding to user queries. For example, method 400 can be performed during staging of the chatbot's knowledge corpus.

In the example, at 402, data is extracted from a digital file. As described herein, the digital file can be a PDF file, or a digital file with another format. The digital file can originate from a data source such as one of data sources 110A . . . N of FIG. 1. As an example, the digital file can include label data for an agricultural product (e.g., a product that contains one or more agricultural chemicals). While method 400 describes extracting data from a single digital file, in practice, the method can be performed for multiple digital files (e.g., in parallel or sequentially).

At 404, the extracted data is processed to generate semantically coherent text segments. This can include the chatbot system applying a natural language processing algorithm to group text of the extracted data into text segments (e.g., “chunks” of text), where each text segment contains relevant context for a specific subsection of the digital file. The natural language processing algorithm can be a proprietary natural language algorithm which leverages a combination of open-source software and proprietary code. The chatbot system can store an internal representation of the natural language processing algorithm in memory.

Applying the natural language processing algorithm to group the text of the extracted data into text segments can include detecting formatting data and/or metadata tags in the extracted data. The formatting data and/or metadata tags can include section titles, table headings, etc. The text of the extracted data can then be grouped, using the natural language processing algorithm, into a set of preliminary text segments based on the detected formatting and/or metadata tags.

The preliminary text segments generated by the algorithm may be broken-up and incoherent. Accordingly, after grouping the text into the set of preliminary text segments, the natural language processing algorithm can identify any text segments that would benefit from recombination among the set of preliminary text segments. The identified text segments can be removed from the set of preliminary text segments and recombined as appropriate. The recombined text segments can then be added to the set of preliminary text segments.

The natural language processing algorithm can also include determining that a selected preliminary text segment requires additional context from an adjacent portion of the text. In response to such a determination, the selected preliminary text segment can be concatenated with the additional context. After any necessary recombining and/or concatenation has been performed on the set of preliminary text segments, the text segments in the set can be referred to as semantically coherent text segments.

At 406, the extracted data is processed to generate question-answer pairs. This can include the chatbot system applying another LLM (e.g., another one of LLMs 170) to generate question-answer pairs from the text of the extracted data. The LLM used in this context can be a chat-tailored LLM, for example. The chatbot system can submit a prompt to the chat-tailored LLM which asks the LLM to summarize a single one of the semantically coherent text segments (e.g., the semantically coherent text segments produced at 404) by generating a set of questions and their answers based on that text segment. The questions and answers regarding the original text that are generated by the LLM will produce a text block which might more closely resemble (semantically) a future user's hypothetical query. Further, because the chatbot system is configured to search for text segments based on embedding vector similarity as described herein, producing a more similar text to a user's query can give the chatbot system a better chance of finding the correct information to respond to the query.

At 408, vector embeddings are generated for the text segments and question-answer pairs. For example, the chatbot system can generate a vector embedding for a semantically coherent text segment by encoding semantic information associated with the semantically coherent text segment into a fixed-length numeric vector. Similarly, the chatbot system can generate a vector embedding for a question-answer pair by encoding semantic information associated with the question-answer pair into a fixed-length numeric vector.

At 410, the vector embeddings and extracted data are ingested into a database. For example, the vector embeddings as well as the extracted data (e.g., the unmodified extracted data) can be ingested into a vector database as entries. The database can be part of the knowledge corpus of the chatbot system, for example.

### Example 6—Example Flow Diagram for Generating Vector Embeddings from a PDF File

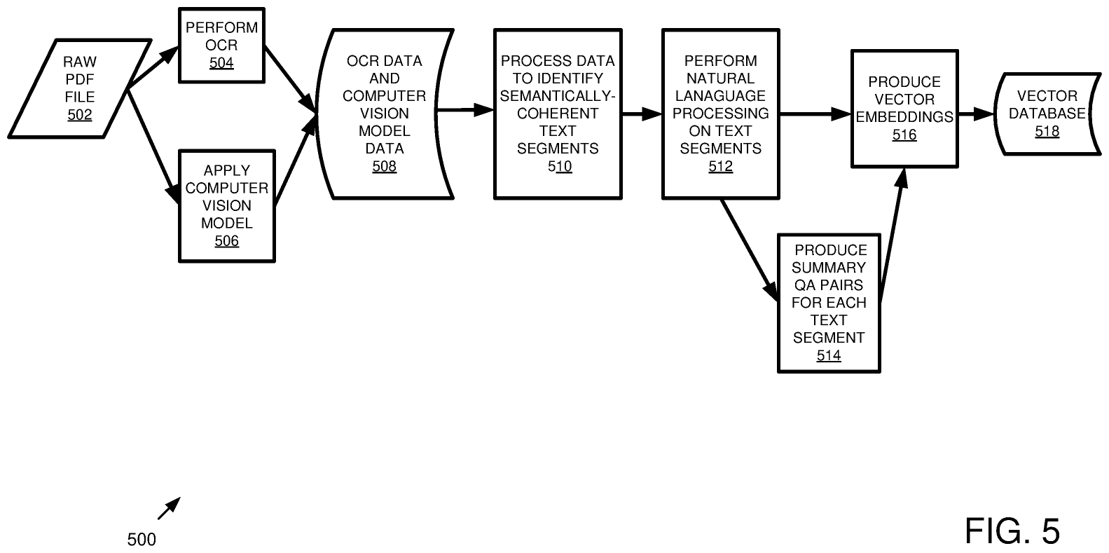

FIG. 5 is a flow diagram 500 depicting data and processes associated with generating vector embeddings from a PDF file and can be performed, for example, by the system of FIG. 1. In particular, diagram 500 corresponds an example of the method of FIG. 4 in which the digital file is a PDF.

In the example, a raw PDF file is shown at 502. Optical character recognition (OCR) is performed on the PDF file at 504. Performing OCR on the PDF file can include extracting text and other data from the PDF file. The other data can include formatting data and metadata tags (e.g., section titles, table headings, etc.).

At 506, a Computer Vision Model is applied to the PDF file. Applying a Computer Vision Model to the PDF file can include extracting tabular data (e.g., data related to tables present in the PDF file) from the PDF file.

The OCR data and Computer Vision Model data, shown at 508, is then processed at 510 to identify semantically coherent text segments, e.g., in the manner described herein with reference to FIG. 4.

At 512, natural language processing is performed on the identified semantically coherent text segments, e.g., in the manner described herein with reference to FIG. 4.

At 514, summary question-answer pairs are produced for each text segment. For example, the chatbot system can apply an LLM (e.g., one of LLMs 170 of FIG. 1) to produce question-answer pairs from the text of the extracted data, e.g., from the semantically coherent text segments. The question-answer pairs can act as a form of summarization of the text. Because the vector embedding for a question-answer pair may be very similar to a hypothetical user text query, include such vector embeddings in the database can help the chatbot system to fetch text segments which are better-matched to answer users' questions.

At 516, vector embeddings are produced. The vector embeddings produced can include a vector embedding for each semantically coherent text segment, as well as a vector embedding for each question-answer pair.

At 518, the vector embeddings are ingested into a vector database. The vector database can then be subsequently accessed by the chatbot system during formulation of an LLM prompt for a user query.

### Example 7—Example Method for Selecting a Database Entry Relevant to a Chatbot Query

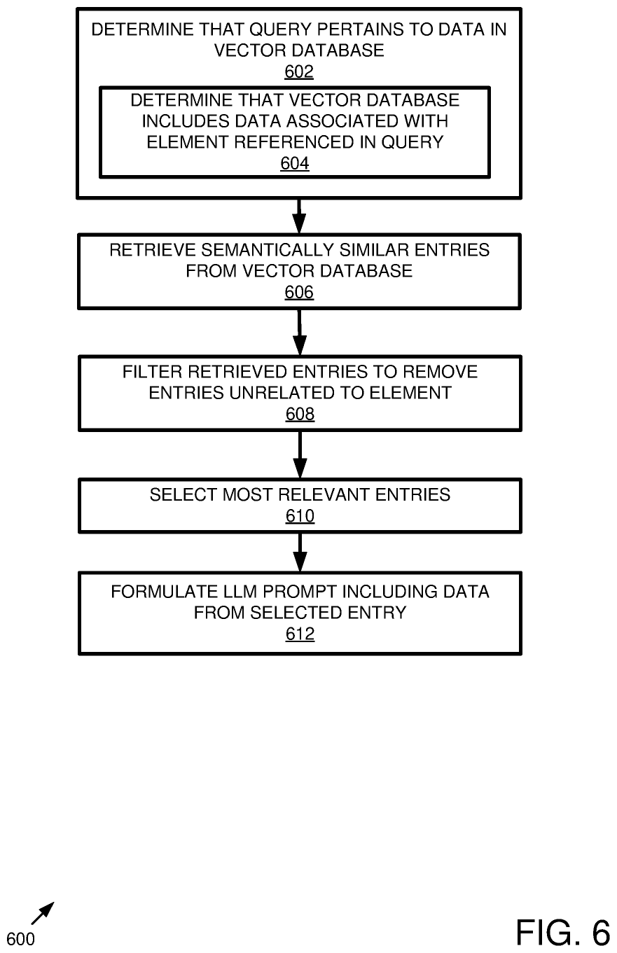

FIG. 6 is a flowchart of an example method 600 for selecting a database entry relevant to a chatbot query, such as a query input by a user to a user interface of an AI agricultural advisor chatbot, and can be performed, for example, by the system of FIG. 1.

In the example, at 602, it is determined that a text query input to a chatbot pertains to data in a vector database. As shown, this includes determining at 604 that the vector database includes data associated with an element referenced in the query (e.g., data associated with an agricultural product, chemical, crop, pest, or other entity.) The determination can be made by applying an LLM to the query (e.g., one of LLMs 170 of FIG. 1). The LLM applied in this context can be a general foundation model, for example.

At 606, one or more entries that are semantically similar to the query are retrieved from the vector database. For example, the chatbot system can initiate a retrieval process which searches the vector database for entries which have similar semantic information to the query. The vector entries searched can include both the raw text and the summarized question text (e.g., question-answer pairs). When a text segment corresponding to a summarized question-answer pair is selected, the actual content returned from the search will be the original text from the digital file from which the question was generated.

At 608, the retrieved entries are filtered to remove entries unrelated to the element referenced in the query. For example, if the element referenced in the query is an agricultural product whose label data has been processed and ingested in the vector database, the chatbot system can filter the retrieved entries to remove entries that originated in the label data for a different agricultural product. This step is important as even a semantically similar text segment from a different product's label would not be applicable.

At 610, the most relevant entries are selected from among the remaining entries. For example, after the chatbot system retrieves the initial results from the database, it can apply another specialized LLM (e.g., another one of LLMs 170) to find the entries most relevant to answering the user's question. This LLM can be a cross-encoder model which is fine-tuned to compare two text entries and provide a score that rates their similarity. Towards this end, the LLM can identify, among the initial results, two entries with the highest relevance to the query. The specialized LLM can then generate, for each of the two entries with the highest relevance to the query, a score rating the similarity of the entry to the query, and select, among the two entries, the entry with a higher value for the score as the entry that is most relevant to the query. This additional step is performed after the initial semantic vector search because cross-encoder models more accurately rank the similarity of text entries due to their fine-tuning for that application; the tradeoff is that cross-encoder comparison is not tenable for large amounts of text pairs, and thus the method includes narrowing in on a candidate set before applying cross-encoder reranking to select the most similar entries.

At 612, a prompt for an LLM is formulated, the prompt including data from the selected entry. The data from the selected entry can include the text and tabular elements originally extracted from the digital file which were selected, via the procedure described above, to provide the most relevant content for answering the query. The prompt can include structured examples of questions and responses to guide the LLM to produce a response which best matches a desired output in format, tone, and content. An example structure of the prompt is set forth below.
[Instructions on guardrails, desired output tone, output formatting]
[Generalized examples that demonstrate the above instructions in practice]
[Relevant factual content to supplement the foundation LLM's knowledge base]

### Example 8—Example Architecture

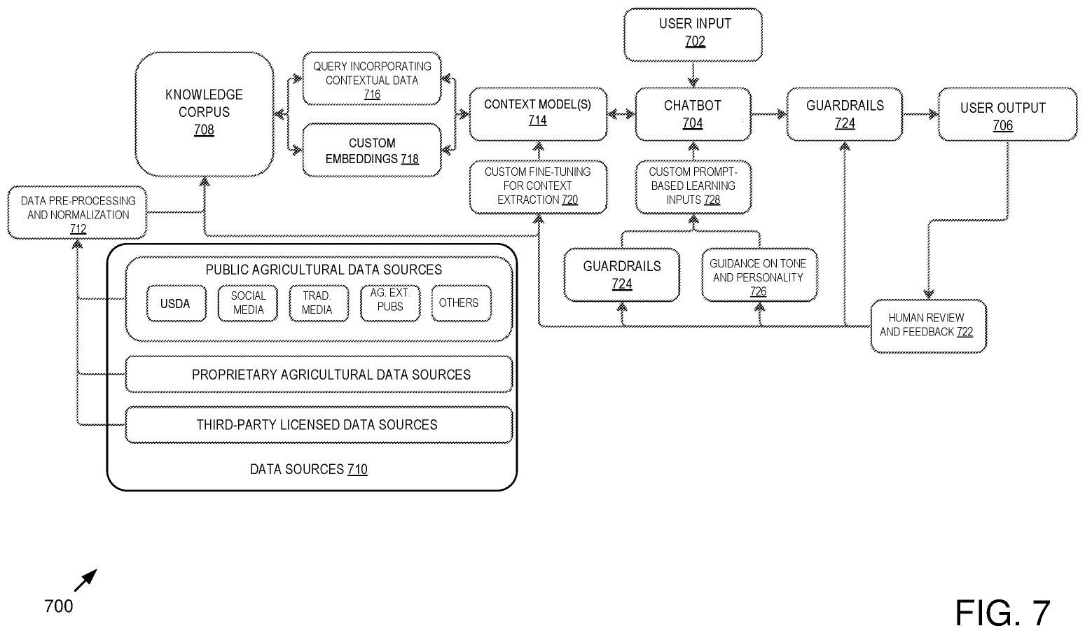

FIG. 7 is a block diagram of an example architecture of an AI agricultural advisor chatbot system 700 that can be used in any of the examples herein. The architecture of chatbot system 700 can be considered an example of a Retrieval-Augmented Generation (RAG) architecture, in which receipt of a query triggers the retrieval of custom data from a database which is then incorporate in a prompt to an LLM which formulates a response to the query.

The chatbot system 700 receives user input 702 to a chatbot 704, which can correspond to chatbot 140 of FIG. 1. The various components of chatbot system 700 can be accessed by the chatbot 704 to formulate a prompt for an LLM based on the user input 702, and optionally, to fine-tune the output of the LLM to the prompt before it is output to the user as user output 706.

As shown, chatbot system 700 includes a knowledge corpus 708 which receives data from data sources 710. Data sources 710 can include public agricultural data sources (e.g., USDA data, social media data, traditional media data, data from agricultural extension publications, etc.), proprietary agricultural data sources (e.g., an internal product recommendation system, live pricing and availability data, etc.), and third-party licensed data sources (e.g., structured product registration data, weather data, etc.), among other data sources. In some examples, the data undergoes data pre-processing and normalization at 712 before being ingested into the knowledge corpus 708. As described herein, the data pre-processing can include generation of vector embeddings representing semantically coherent text segments and question-answer pairs.

Upon receipt of the user input 702 (e.g., a user query), the chatbot system 700 can utilize context model(s) 714 to incorporate contextual data into the query as shown at 716. Custom embeddings 718 (e.g., vector embeddings) relevant to the query can be obtained from the knowledge corpus 708. In some examples, custom fine-tuning is performed during the context extraction process, as shown at 720, which can take into account human review and feedback 722. Human review and feedback 722, which can also be referred to as human-in-loop function, can aid in the training and fine-tuning process. For example, as shown, the human review and feedback 722 can serve as an input to the generation of guidance on tone and personality, as shown at 726.

To ensure quality results, the chatbot system 700 can include a series of heuristic-based guardrails 724. The guardrails 724 can include one or more of a topical layer that restricts the chatbot to agriculture-related topics; a legal review layer that intercepts all responses that might violate local, state, or federal laws; and a trust and safety layer that ensures civil and constructive responses. As shown, the guardrails 724, along with the guidance on tone and personality 726, can be used to generate custom prompt-based learning inputs 728 for use by chatbot 704.

### Example 9—Other Example Use Cases

In any of the examples herein, an implementation can perform the following use cases, in addition to those describe above.

As one example, the chatbot system described herein can implement a cart development support in-shop experience for users accessing a website or Cloud service which sells agricultural products. Similarly, the chatbot system can act as a customer experience (CX) chatbot in such contexts.

As another example, a user (e.g., a farmer) can utilize the chatbot system described herein to obtain answers to general questions related to agronomy.

As yet another example, the chatbot system described herein can be used to implement an active response option within the context of a provider's social media platform (e.g., a community forum associated with the provider).

Further, the chatbot system can be used to facilitate automated data capture for agronomic contexts, e.g., by assisting with capture of data pertaining to agricultural attributes such as crop yield, nutrition plan, and chemical plan.

The chatbot system described herein can also be used to guide users to features within a provider's offerings. For example, a user can submit a query regarding a desired feature, and the chatbot system can return a response listing one or more products offered by the provider which provide the specified feature.

In addition, the chatbot system described herein can include “farmer verification” functionality. For example, the chatbot can present a series of questions to a user that are designed to determine if the user is indeed a farmer. Such functionality could assist with a provider's farmer verification process.

As another example, the knowledge corpus of the chatbot system can be populated with information from a seed selection tool. The chatbot system can then function as consultative seed salesperson by answering questions from users regarding seed selection (e.g., “What's the best variety for my location?”).

Further, the chatbot system's knowledge corpus can be configured to access real-time data (e.g., weather data, grain market data, news data, etc.), such that users can query the chatbot system to obtain updated information on such topics.

Other example use cases for the chatbot system can include facilitating semantic data queries regarding agricultural Direct Benefit Transfer (DBT) mechanisms, generative agricultural appraisal narratives, and generating agricultural loan narratives.

### Example 10—Example Computing Systems

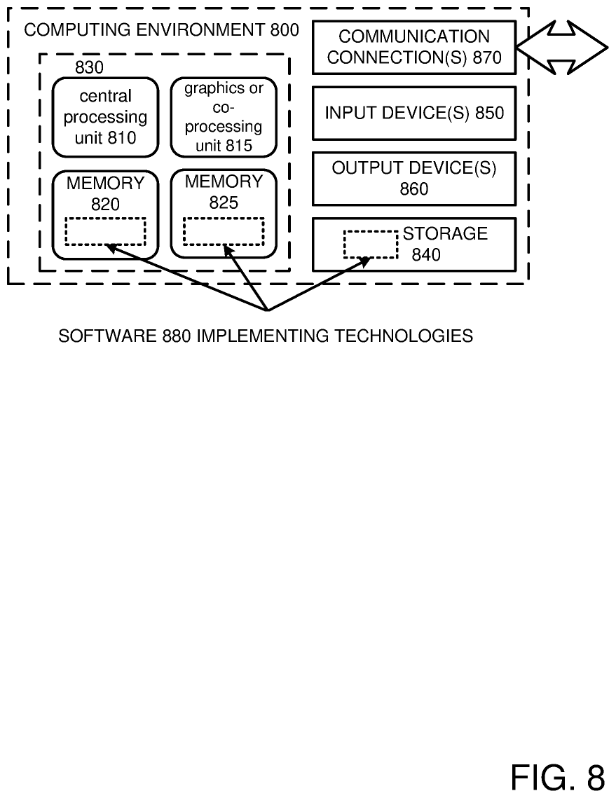

FIG. 8 depicts an example of a suitable computing system 800 in which the described innovations can be implemented. The computing system 800 is not intended to suggest any limitation as to scope of use or functionality of the present disclosure, as the innovations can be implemented in diverse computing systems.

With reference to FIG. 8, the computing system 800 includes one or more processing units 810, 815 and memory 820, 825. In FIG. 8, this basic configuration 830 is included within a dashed line. The processing units 810, 815 execute computer-executable instructions, such as for implementing the features described in the examples herein. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 8 shows a central processing unit 810 as well as a graphics processing unit or co-processing unit 815. The tangible memory 820, 825 can be volatile memory (e.g., registers, cache, RAM), non-volatile memory (e.g., ROM, EEPROM, flash memory, etc.), or some combination of the two, accessible by the processing unit(s) 810, 815. The memory 820, 825 stores software 880 implementing one or more innovations described herein, in the form of computer-executable instructions suitable for execution by the processing unit(s) 810, 815.

A computing system 800 can have additional features. For example, the computing system 800 includes storage 840, one or more input devices 850, one or more output devices 860, and one or more communication connections 870, including input devices, output devices, and communication connections for interacting with a user. An interconnection mechanism (not shown) such as a bus, controller, or network interconnects the components of the computing system 800. Typically, operating system software (not shown) provides an operating environment for other software executing in the computing system 800, and coordinates activities of the components of the computing system 800.

The tangible storage 840 can be removable or non-removable, and includes magnetic disks, magnetic tapes or cassettes, CD-ROMs, DVDs, or any other medium which can be used to store information in a non-transitory way and which can be accessed within the computing system 800. The storage 840 stores instructions for the software 880 implementing one or more innovations described herein.

The input device(s) 850 can be an input device such as a keyboard, mouse, pen, or trackball, a voice input device, a scanning device, touch device (e.g., touchpad, display, or the like) or another device that provides input to the computing system 800. The output device(s) 860 can be a display, printer, speaker, CD-writer, or another device that provides output from the computing system 800.

The communication connection(s) 870 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the context of computer-executable instructions, such as those included in program modules, being executed in a computing system on a target real or virtual processor (e.g., which is ultimately executed on one or more hardware processors). Generally, program modules or components include routines, programs, libraries, objects, classes, components, data structures, etc. that perform particular tasks or implement particular abstract data types. The functionality of the program modules can be combined or split between program modules as desired in various embodiments. Computer-executable instructions for program modules can be executed within a local or distributed computing system.

For the sake of presentation, the detailed description uses terms like “determine” and “use” to describe computer operations in a computing system. These terms are high-level descriptions for operations performed by a computer and should not be confused with acts performed by a human being. The actual computer operations corresponding to these terms vary depending on implementation.

### Example 11—Computer-Readable Media

Any of the computer-readable media herein can be non-transitory (e.g., volatile memory such as DRAM or SRAM, nonvolatile memory such as magnetic storage, optical storage, or the like) and/or tangible. Any of the storing actions described herein can be implemented by storing in one or more computer-readable media (e.g., computer-readable storage media or other tangible media). Any of the things (e.g., data created and used during implementation) described as stored can be stored in one or more computer-readable media (e.g., computer-readable storage media or other tangible media). Computer-readable media can be limited to implementations not consisting of a signal.

Any of the methods described herein can be implemented by computer-executable instructions in (e.g., stored on, encoded on, or the like) one or more computer-readable media (e.g., computer-readable storage media or other tangible media) or one or more computer-readable storage devices (e.g., memory, magnetic storage, optical storage, or the like). Such instructions can cause a computing system to perform the method. The technologies described herein can be implemented in a variety of programming languages.

### Example 12—Example Cloud Computing Environment

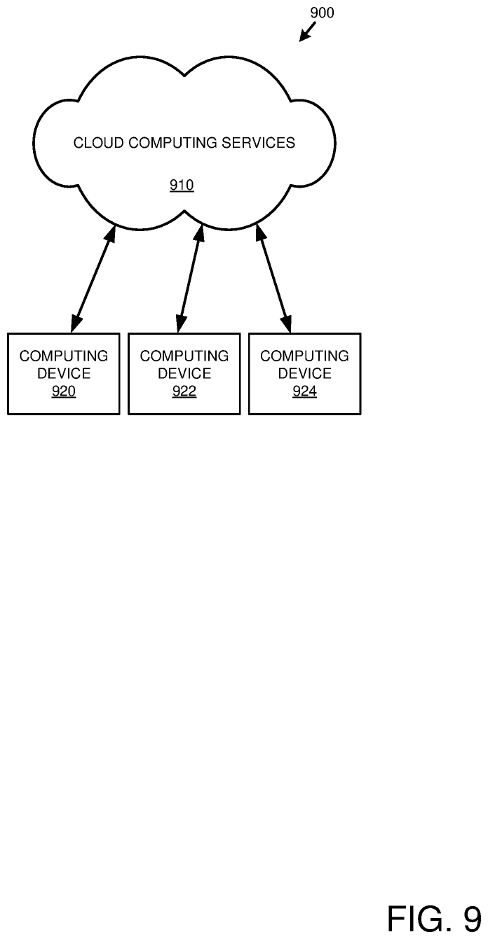

FIG. 9 depicts an example cloud computing environment 900 in which the described technologies can be implemented, including, e.g., the system 100 of FIG. 1 and other systems herein. The cloud computing environment 900 comprises cloud computing services 910. The cloud computing services 910 can comprise various types of cloud computing resources, such as computer servers, data storage repositories, networking resources, etc. The cloud computing services 910 can be centrally located (e.g., provided by a data center of a business or organization) or distributed (e.g., provided by various computing resources located at different locations, such as different data centers and/or located in different cities or countries).

The cloud computing services 910 are utilized by various types of computing devices (e.g., client computing devices), such as computing devices 920, 922, and 924. For example, the computing devices (e.g., 920, 922, and 924) can be computers (e.g., desktop or laptop computers), mobile devices (e.g., tablet computers or smart phones), or other types of computing devices. For example, the computing devices (e.g., 920, 922, and 924) can utilize the cloud computing services 910 to perform computing operations (e.g., data processing, data storage, and the like).

In practice, cloud-based, on-premises-based, or hybrid scenarios can be supported.

### Example 13—Example Implementations

Although the operations of some of the disclosed methods are described in a particular, sequential order for convenient presentation, such manner of description encompasses rearrangement, unless a particular ordering is required by specific language set forth herein. For example, operations described sequentially can in some cases be rearranged or performed concurrently.

### Example 14—Example Alternatives

The technologies from any example can be combined with the technologies described in any one or more of the other examples. In view of the many possible embodiments to which the principles of the disclosed technology can be applied, it should be recognized that the illustrated embodiments are examples of the disclosed technology and should not be taken as a limitation on the scope of the disclosed technology.

What is claimed is:

1. A computer-implemented method comprising:
extracting data from a digital file, the extracted data comprising text;
processing the extracted data to generate semantically coherent text segments;
processing the extracted data to generate question-answer pairs;
generating a vector embedding for each semantically coherent text segment;
generating a vector embedding for each question-answer pair;
ingesting the vector embeddings into a database as entries;
receiving a text query;
identifying, among the entries in the database, an entry that is most relevant to the query and retrieving the identified entry; and
formulating a prompt for a large language model (LLM) based on the query, the prompt incorporating data from the retrieved entry.

2. The method of claim 1, wherein the prompt comprises structured examples of questions and answers.

3. The method of claim 1, further comprising:
submitting the prompt to the LLM;
obtaining a response to the prompt from the LLM; and
outputting the response as an answer to the query.

4. The method of claim 1, wherein processing the extracted data to generate the semantically coherent text segments comprises applying a natural language processing algorithm to group the text into the semantically coherent text segments, and wherein each semantically coherent text segment contains relevant context for a specific subsection of the digital file.

5. The method of claim 4, wherein applying the natural language processing algorithm to group the text into the semantically coherent text segments comprises:
detecting formatting and/or metadata tags in the extracted data;
grouping the text into a set of preliminary text segments based on the detected formatting and/or metadata tags;
identifying text segments for recombination among the set of preliminary text segments;
recombining the identified text segments and adding the recombined text segments to the set of preliminary text segments;
determining that a selected preliminary text segment requires additional context from an adjacent portion of the text; and
concatenating the selected preliminary text segment with the additional context.

6. The method of claim 1, wherein generating the vector embedding for each semantically coherent text segment comprises encoding semantic information associated with the semantically coherent text segment into a fixed-length numeric vector.

7. The method of claim 1, wherein the text query comprises a reference to an element, and wherein identifying the entry that is most relevant to the query comprises initiating a retrieval process in which entries which are semantically similar to the query and which originated from a digital file that references the element are retrieved from the database.

8. The method of claim 7, wherein the element is selected from the group consisting of a product, a chemical, a crop, and a pest.

9. The method of claim 7, wherein identifying the entry that is most relevant to the query further comprises identifying, among the entries retrieved from the database, an entry that is most relevant to the query.

10. The method of claim 9, wherein the LLM is a first LLM, wherein the retrieval process is performed by applying a second LLM, and wherein the identification of the entry that is most relevant to the query is performed by applying a third LLM.

11. The method of claim 10, wherein processing the extracted data to generate the question-answer pairs comprises applying a fourth LLM to generate the question-answer pairs from the text.

12. The method of claim 10, wherein the third LLM comprises a cross-encoder model, and wherein applying the third LLM to identify the entry that is most relevant to the query comprises:
identifying, among the entries retrieved from the database, two entries with a highest relevance to the query;
generating, for each of the two entries, a score rating the similarity of the entry to the query; and
selecting, among the two entries, the entry with a higher value for the score as the entry that is most relevant to the query.

13. The method of claim 7, wherein the digital file is a PDF, and wherein extracting the data from the PDF comprises performing Optical Character Recognition (OCR) on the PDF and/or applying a Computer Vision Model to the PDF.

14. The method of claim 13, wherein the element is an agricultural product, and wherein the PDF comprises label data for the agricultural product.

15. The method of claim 14, wherein the label data comprises usage instructions for the agricultural product.

16. A computing system comprising:
at least one hardware processor;
at least one memory coupled to the at least one hardware processor;
a database storing as entries a plurality of vector embeddings generated based on data extracted from digital files containing label data for agricultural products; and
one or more non-transitory computer-readable media having stored therein computer-executable instructions that, when executed by the computing system, cause the computing system to perform:
receiving a text query comprising a reference to one of the agricultural products;
identifying, among the entries in the database, an entry that is most relevant to the query and retrieving the identified entry;
formulating a prompt for a large language model (LLM) based on the query, the prompt incorporating data from the retrieved entry; and
submitting the prompt to the LLM.

17. The system of claim 16, further comprising an internal representation of a natural language processing algorithm configured to group the data extracted from the digital files into semantically coherent text segments, wherein the vector embeddings comprise vector embeddings associated with the semantically coherent text segments.

18. The system of claim 16, wherein the system comprises a Retrieval-Augmented Generation (RAG) architecture in which receipt of the query triggers the retrieval of custom data from the database which is incorporated in the prompt.

19. The system of claim 16, wherein the database further comprises at least two of the following categories of information:
public agronomic information;
semi-public agronomic information;
proprietary agronomic information.

20. One or more non-transitory computer-readable media comprising computer-executable instructions that, when executed by a computing system, cause the computing system to perform operations comprising:
populating a database with data extracted from digital files comprising label data for a plurality of agricultural products, including processing the extracted data to generate semantically coherent text segments and question-answer pairs, generating a vector embedding for each semantically coherent text segment and question-answer pair, and ingesting the vector embeddings into the database as entries;
with an artificial intelligence agricultural advisor chatbot, receiving a text query comprising a reference to one of the agricultural products;
identifying, among the entries in the database, an entry that is most relevant to the query and retrieving the identified entry;
formulating a prompt for a large language model (LLM) based on the query, the prompt incorporating data from the retrieved entry;
submitting the prompt to the LLM;
obtaining a response to the prompt from the LLM; and
outputting the response as an answer to the query.
